(19) United States
(12) Patent Application Publication
(10) Pub. No.: US 2011/0193845 A1
(43) Pub. Date: Aug. 11, 2011

(54) METHOD OF DRIVING ELECTROPHORETIC DISPLAY DEVICE, AND CONTROLLER

(75) Inventor: Yusuke YAMADA, Shiojiri (JP)

(73) Assignee: SEIKO EPSON CORPORATION, Tokyo (JP)

(21) Appl. No.: 13/012,115

(22) Filed: Jan. 24, 2011

(30) Foreign Application Priority Data
Feb. 5, 2010 (JP) 2010-024154

(51) Int. Cl. G09G 5/00; G09G 3/30

(52) U.S. Cl. 345/211; 345/76

(57) ABSTRACT

A method of driving an electrophoretic display device is a method of driving an electrophoretic display device provided with a plurality of pixels with an electrophoretic layer interposed between a first electrode and a second electrode, a first display state is selected as a display state of the pixels by applying a positive voltage, a second display state is selected as a display state of the pixels by applying a negative voltage, a halftone between the first display state and the second display state is selected according to a total continuation time of the negative voltage applied to the pixels in the first display state, and a positive compensation voltage pulse is applied after applying at least one negative driving voltage pulse to select the halftone.

### BACKGROUND

1. Technical Field

The present invention relates to a method of driving an electrophoretic display device.

2. Related Art

In such a type of electrophoretic display device, a driving voltage is applied to an electrophoretic layer including, for example, white and black electrophoretic particles interposed between pixel electrodes and a common electrode for each of a plurality of pixels to move the electrophoretic particles, thereby displaying an image. A halftone (e.g., gray) is displayed by changing a time of applying the driving voltage to the electrophoretic layer for each pixel.

As such a type of electrophoretic display device, there is a device provided with a pixel circuit (a so-called 1T1C-type pixel circuit) including one TFT (Thin Film Transistor) serving as a pixel switching element and one capacitor (i.e., a condenser) serving as a memory circuit.

For example, JP-A-2007-79170 discloses, for an electrophoretic display device, a technique of avoiding non-uniform color display by changing a time in which a driving voltage according to a continuous display time is applied before changing a display color when a display color is changed.

In such a kind of electrophoretic display device, there is a technical problem that a noise may occur in a displayed image with a halftone. That is, even when the same driving voltage is applied to display the same halftone on different pixels, different halftones may be displayed depending on the pixel. Such a difference of halftones actually displayed by two pixels set to display the same halftone is recognized as a noise of the image. When the halftone is displayed, the noise tends to significantly occur as the driving voltage application time to display the halftone gets shorter. Although a cause thereof is not clear, for example, in the electrophoretic display device provided with the 1T1C-type pixel circuits, it is thought that the non-uniformity (in other words, a difference in capacitor characteristics among the capacitors provided in the pixels) of production of the capacitors included in the pixel circuits is one the of causes.

### SUMMARY

An advantage of some aspects of the invention is to provide a method of driving an electrophoretic display device capable of reducing a noise when displaying halftones and capable of performing high-quality display.

According to an aspect of the invention, there is provided a method of driving an electrophoretic display device provided with a plurality of pixels with an electrophoretic layer interposed between a first electrode and a second electrode, wherein when assuming that a potential difference occurring between the first electrode and the second electrode is positive when a potential of the first electrode is higher than a potential of the second electrode, a first display state is selected as a display state of the pixels by applying the positive voltage, a second display state is selected as a display state of the pixels by applying a negative voltage different from the positive voltage, and a halftone between the first display state and the second display state is selected according to a total continuation time of the negative voltage applied to the pixels in the first display state, the method including applying a positive compensation voltage pulse after applying at least one negative driving voltage pulse to select the halftone.

In the electrophoretic display device according to the aspect of the invention, one polarity, for example, a positive voltage is applied, at least one polar reverse to the one polar, for example, at least one negative driving voltage pulse is applied, and a positive compensation voltage pulse is further applied to pixels in the first display state (e.g., white), thereby displaying a halftone (half gradation) that is, for example, gray for the pixels. In addition, the potential of the first electrode is lower than the potential of the second electrode for only a predetermined continuation time by applying at least one negative driving voltage pulse to the pixels. Accordingly, when a plurality of negative driving voltage pulses are applied to the pixels, the potential of the first electrode is lower than the potential of the second electrode for the total continuation time obtained by summing continuation times of the plurality of negative driving voltage pulses.

In the invention, particularly, to select the halftone, when assuming that a potential difference occurring between the first electrode and the second electrode is positive in a case where a potential of the first electrode is higher than a potential of the second electrode, the positive compensation voltage pulse is applied after applying at least one negative driving voltage pulse. That is, to display the halftone, first, at least one negative driving voltage pulse is applied to the pixels in the first display state. Accordingly, the display state of the pixels is changed from the first display state to the second display state, and becomes a halftone state according to the total continuation time of the negative driving voltage pulses. Then, the positive compensation voltage pulse is applied to the pixels. The time of applying the compensation voltage pulse to the pixels may be after applying all the negative driving voltage pulses necessary to display a predetermined halftone, and may be after applying any of the necessary negative driving voltage pulses.

According to the invention, it is possible to reduce or remove a noise of the displayed image, as compared with the case of displaying the halftone by applying only the negative driving voltage pulse to the pixels for which the halftone has to be displayed. That is, it is possible to reduce the occurrence of the different halftones being displayed among the pixels for which the same halftone has to be displayed. As a result, it is possible to perform high-quality display.

As described above, according to the method of driving the electrophoretic display device according to the aspect of the invention, it is possible to reduce the noise when displaying the halftone, and thus it is possible to perform the high-quality display.

In the method of driving the electrophoretic display device according to the aspect of the invention, the continuation time of the compensation voltage pulse may be shorter than the total continuation time of at least one negative driving voltage pulse.

According to the aspect, it is possible to effectively reduce or remove the noise of the displayed image. In addition, it is possible to rapidly display the halftone as compared with a case where the continuation time of the positive compensation voltage pulse is longer than the total continuation time of at least one negative driving voltage pulse. That is, it is possible to shorten the time necessary to display the halftone to be displayed. Moreover, it is possible to suppress power consumption necessary to apply the positive compensation voltage pulse.

In the method of driving the electrophoretic display device according to an another aspect of the invention, the continuation time of the compensation voltage pulse may be longer than the total continuation time of at least one negative driving voltage pulse.

According to the aspect, for example, when the positive voltage is applied to the pixels, it is possible to reliably display the halftone to be displayed by applying the positive compensation voltage pulse even when it is difficult to move electrophoretic particles included in the electrophoretic layer, as compared with a case of applying the negative voltage.

In addition, for example, the continuation time of the positive compensation voltage pulse may be set on the basis of characteristics (e.g., ease of movement of electrophoretic particles) of the electrophoretic particles included in the electrophoretic layer.

In the method of driving the electrophoretic display device of another aspect of the invention, the compensation voltage pulse may be applied after applying all of at least one negative driving voltage pulse.

According to the aspect, for example, it is possible to rapidly display the halftone, as compared with the case of applying the positive compensation voltage pulse whenever one negative driving voltage pulse of at least one negative driving voltage pulse is applied. That is, it is possible to shorten the time necessary to display the halftone to be displayed. Furthermore, it is possible to suppress power consumption necessary to apply the positive compensation voltage pulse.

In the method of driving the electrophoretic display device according to another aspect of the invention, the compensation voltage pulse may not be applied to the pixels for which the second display state is selected.

According to the aspect, it is possible to reliably make the display state of the pixels to display the second display state into the second display state.

That is, in the aspect, when the pixels in the first display state (e.g., white) are changed to the second display state (e.g., black), only the negative driving voltage pulse is applied to the pixels, and the positive compensation voltage pulse is not applied. Accordingly, it is possible to prevent the pixels which are to be the second display state from being a display state (e.g., gray) closer to the first display state than the second display state by applying the positive compensation voltage pulse.

In the method of driving the electrophoretic display device according to another aspect of the invention, a driving voltage pulse with the longest continuation time of at least one negative driving voltage pulse may be lastly applied, and the compensation voltage pulse may be applied just before the lastly applied driving voltage pulse.

According to the aspect, it is possible to prevent the pixels from being closer to the first display state than a display state to be displayed (the halftone or the second display state) by applying the positive compensation voltage pulse. Accordingly, it is possible to increase the contrast of the displayed image.

Operations and other advantages of the invention will be clarified by embodiments of the invention to be described below.

### BRIEF DESCRIPTION OF THE DRAWINGS

The invention will be described with reference to the accompanying drawings, wherein like numbers reference like elements.

FIG. 1 is a block diagram illustrating an overall configuration of an electrophoretic display device according to a first embodiment.

FIG. 2 is an equivalent circuit diagram illustrating an electrical configuration of pixels of the electrophoretic display device according to the first embodiment.

FIG. 3 is a partial cross-sectional view of a display unit of the electrophoretic display device according to the first embodiment.

FIG. 4 is a schematic view illustrating a configuration of a microcapsule.

FIG. 5 is schematic view illustrating the display unit of the electrophoretic display device in a state of displaying an example of an image including a halftone.

FIG. 6 is a flowchart illustrating a method of driving the electrophoretic display device according to the first embodiment.

FIG. 7 is a conceptual diagram illustrating an operation of the electrophoretic display device according to the first embodiment.

FIG. 8 is a timing chart for describing the method of driving the electrophoretic display device according to the first embodiment.

FIG. 9 is a timing chart for describing a method of driving the electrophoretic display device according to a second embodiment.

FIG. 10 is a schematic view illustrating the display unit of the electrophoretic display device in a state of displaying an example of an image including a plurality of halftones.

FIG. 11 is a timing chart for describing a method of driving the electrophoretic display device according to a third embodiment.

FIG. 12 is a timing chart for describing a method of driving the electrophoretic display device according to a fourth embodiment.

FIG. 13 is a timing chart for describing a method of driving the electrophoretic display device according to a fifth embodiment.

### DESCRIPTION OF EXEMPLARY EMBODIMENTS

Hereinafter, embodiments of the invention will be described with reference to the drawings.

### First Embodiment

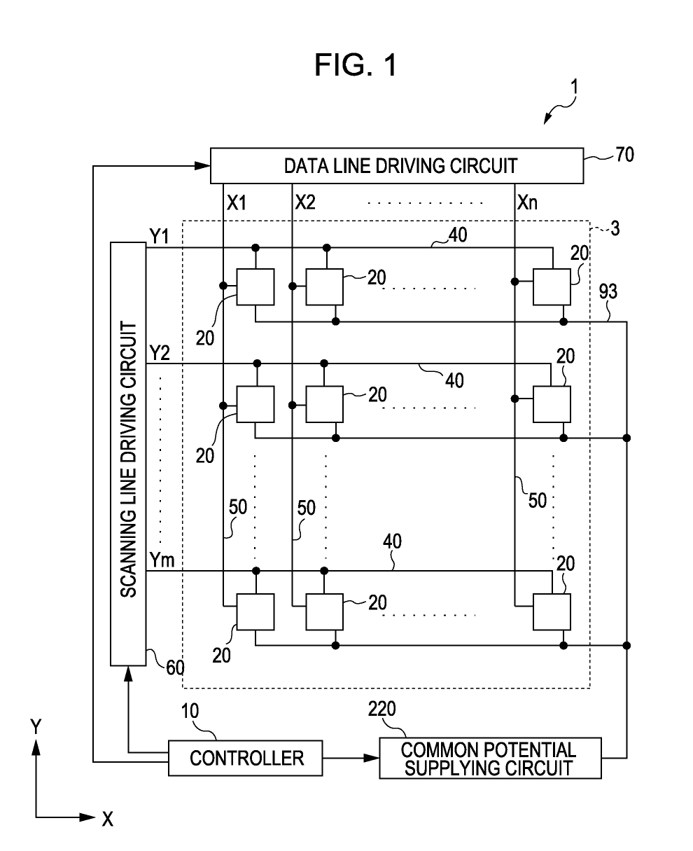

A method of driving an electrophoretic display device according to a first embodiment will be described with reference to FIG. 1 to FIG. 8.

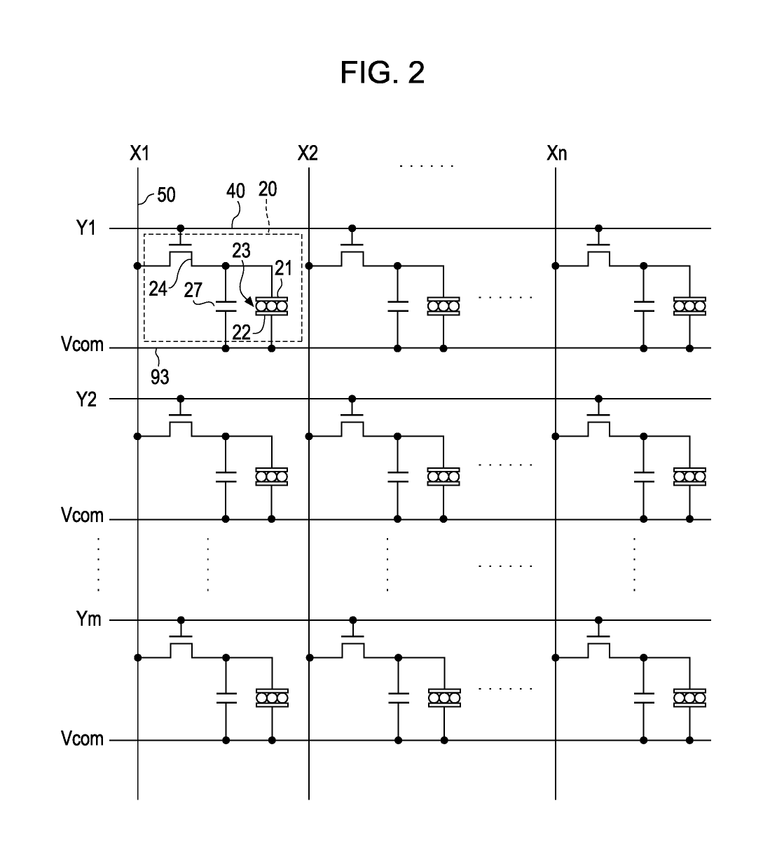

First, an overall configuration of the electrophoretic display device according to the embodiment will be described with reference to FIG. 1 and FIG. 2.

FIG. 1 is a block diagram illustrating the overall configuration of the electrophoretic display device according to the embodiment.

In FIG. 1, the electrophoretic display device 1 according to the embodiment is provided with a display unit 3, a controller 10, a scanning line driving circuit 60, a data line driving circuit 70, and a common potential supplying circuit 220.

In the display unit 3, pixels 20 of m rows x n columns are arranged in a matrix (2-dimensional planar). The display unit 3 is provided with m scanning lines 40 (i.e., scanning lines Y1, Y2, . . . , Ym) and n data lines 50 (X1, X2, . . . , Xn) to intersect each other. Specifically, the m scanning lines 40 extend in a row direction (i.e., X direction), and the n data lines 50 extend in a column direction (i.e., Y direction). The pixels 20 are provided corresponding to intersections of the m scanning lines 40 and the n data lines 50.

The controller 10 controls operations of the scanning line driving circuit 60, the data line driving circuit 70, and the common potential supplying circuit 220. The controller 10 supplies, for example, a timing signal such as a clock signal and a start pulse to each circuit.

The scanning line driving circuit 60 supplies a scanning signal to each of the scanning lines Y1, Y2, . . . , Ym on the basis of the timing signal supplied from the controller 10.

The data line driving circuit 70 supplies a data signal to the data lines X1, X2, . . . , Xn on the basis of the timing signal supplied from the controller 10. The data signal takes a binary potential of a high potential VH (e.g., 15V) or a low potential VL (e.g., 0V).

The common potential supplying circuit 220 supplies a common potential Vcom to a common potential line 93.

Although various signals are input to the controller 10, the scanning line driving circuit 60, the data line driving circuit 70, and the common potential supplying circuit 220, description particularly unrelated to the embodiment is omitted.

FIG. 2 is an equivalent circuit diagram illustrating an electrical configuration of the pixels.

In FIG. 2, the pixel 20 is provided with a pixel circuit (i.e., a 1T1C-type pixel circuit) having a pixel switching transistor 24 and a capacitor (keeping capacitance) 27, a pixel electrode 21, a common electrode 22, and an electrophoretic layer 23.

The pixel switching transistor 24 is formed of, for example, an N-type transistor. In the pixel switching transistor 24, a gate thereof is electrically connected to the scanning lines 40, a source thereof is electrically connected to the data line 50, and a drain thereof is electrically connected to the pixel electrode 21 and the capacitor 27. The pixel switching transistor 24 outputs the data signal supplied from the data line driving circuit 70 (see FIG. 1) through the data line 50 to the pixel electrode 21 and the capacitor 27 at the time corresponding to the scanning signal from the scanning line driving circuit 60 (see FIG. 1) through the scanning lines 40.

The data signal is supplied from the data line driving circuit 70 to the pixel electrode 21 through the data line 50 and the pixel switching transistor 24. The pixel electrode 21 is provided to be opposed to the common electrode 22 through the electrophoretic layer 23.

The common electrode 22 is electrically connected to the common potential line 93 to which the common potential Vcom is supplied.

The electrophoretic layer 23 is formed of a plurality of microcapsules including the electrophoretic particles.

The capacitor 27 includes a pair of electrodes opposed through a dielectric film, one electrode is electrically connected to the pixel electrode 21 and the pixel switching transistor 24, and the other electrode is electrically connected to the common potential line 93. The data signal can be kept only during a predetermined period by the capacitor 27.

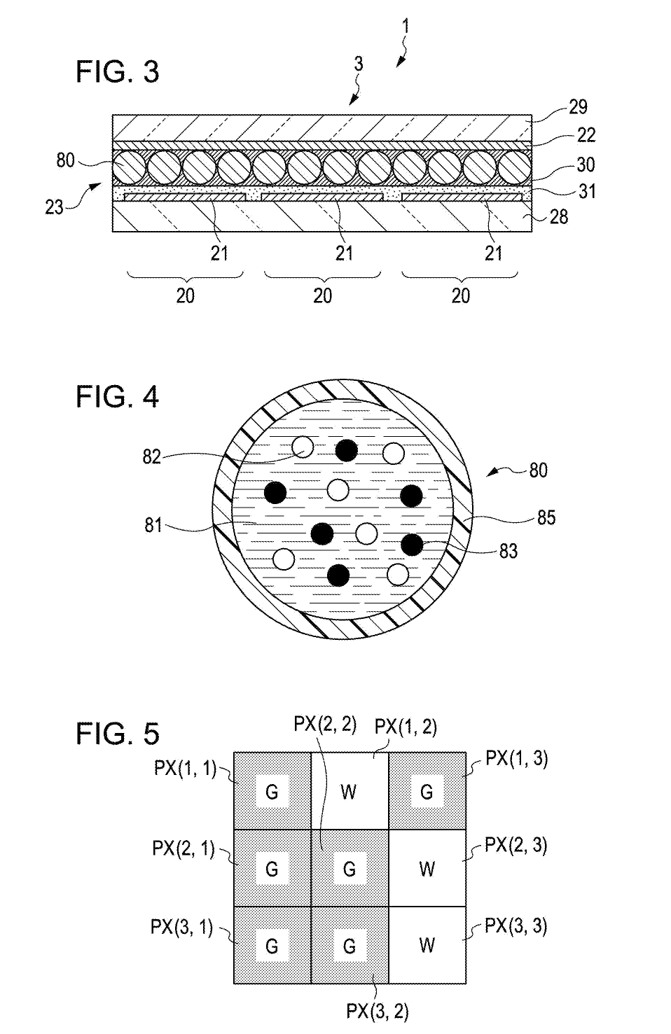

Next, a detailed configuration of the display unit of the electrophoretic display device according to the embodiment will be described with reference to FIG. 3 and FIG. 4.

FIG. 3 is a partial cross-sectional view of the display unit of the electrophoretic display device according to the embodiment.

In FIG. 3, the display unit 3 has a configuration in which the electrophoretic layer 23 is interposed between an element substrate 28 and an opposed substrate 29. The embodiment will be described on the assumption that an image is displayed on the opposed substrate 29 side.

The element substrate 28 is formed of, for example, glass or plastic. Although not shown, a laminated structure having the pixel switching transistors 24, the capacitors 27, the scanning lines 40, the data lines 50, the common potential lines 93, and the like described with reference to FIG. 2 is formed on the element substrate 28. The plurality of pixel electrodes 21 are provided on the upper layer side of the laminated structure in a matrix.

The opposed substrate 29 is a transparent substrate formed of, for example, glass or plastic. On the opposed face of the opposed substrate 29 to the element substrate 28, the common electrode 22 is formed in a solid shape so as to be opposed to the plurality of pixel electrodes 21. The common electrode 22 is formed of, for example, a transparent conductive material such as magnesium silver (MgAg), indium tin oxide (ITO), and indium zinc oxide (IZO).

The electrophoretic layer 23 is formed of a plurality of microcapsules 80 including electrophoretic particles, and is fixed between the element substrate 28 and the opposed substrate 29 by a binder 30 and an adhesive layer 31 formed of, for example, resin. In a production process, the electrophoretic display device 1 according to the embodiment is formed by adhering an electrophoretic sheet in which the electrophoretic layer 23 is fixed in advance on the opposed substrate 29 side by the binder 30, to the element substrate 28 side on which the pixel electrodes 21 and the like are formed, which is separately produced, by the adhesive layer 31.

The microcapsule 80 is interposed between the pixel electrode 21 and the common electrode 22, one or more microcapsules 80 are provided in one pixel 20 (in other words, for one pixel electrode 21).

FIG. 4 is a schematic diagram illustrating a configuration of the microcapsule. In FIG. 4, a cross section of the microcapsule is schematically shown.

In FIG. 4, in the microcapsule 80, a dispersion medium 81, a plurality of white particles 82, and a plurality of black particles 83 are sealed in a film 85. The microcapsule 80 is formed, for example, in a spherical shape having a diameter of about 50 μm.

The film 85 serves as an outer shell of the microcapsule 80, and is formed of acryl resin such as polymethyl methacrylate and polyethyl methacrylate, and polymer resin having transparency such as urea resin, gum arabic, and gelatin.

The dispersion medium 81 is a medium dispersing the white particles 82 and the black particles 83 in the microcapsule 80 (in other words, in the film 85). As the dispersion medium 81, water, alcohol-based solvent such as methanol, ethanol, isopropanol, butanol, octanol, and methyl cellosolve, various esters such as ethyl acetate, and butyl acetate, ketones such as acetone, methyl ethyl ketone, and methyl isobutyl ketone, aliphatic hydrocarbon such as pentane, hexane, and octane, alicyclic hydrocarbon such as cyclohexane and methyl cyclohexane, benzene, toluene, aromatic hydrocarbon such as benzenes having a long-chain alkyl group such as xylene, hexyl benzene, heptyl benzene, octyl benzene, nonyl benzene, decyl benzene, undecyl benzene, dodecyl benzene, tridecyl benzene, and tetradecyl benzene, halogenated hydrocarbon such as methylene chloride, chloroform, carbon tetrachloride, and 1,2-decloroethane, carboxylate, and other oils may be independently used or mixed. A surfactant may be mixed into the dispersion medium 81.

The white particles 82 are particles (polymer or colloid) formed of, for example, white pigments such as titanium dioxide, zinc (zinc oxide), and antimony trioxide, and are, for example, negatively charged.

The black particles 83 are particles (polymer or colloid) formed of, for example, black pigments such as aniline black and carbon black, and are, for example, positively charged.

For this reason, the white particles 82 and the black particles 83 can move in the dispersion medium 81 due to the electric field generated by potential difference between the pixel electrode 21 and the common electrode 22.

A charge control agent formed of particles such as an electrolyte, a surfactant, metal soap, resin, rubber, oil, varnish, and compound, a dispersion agent such as a titanium-based coupling agent, an aluminum-based coupling agent, and a silane-based coupling agent, a lubricant, a stabilizing agent, and the like may be added to such pigments as necessary.

In FIG. 3, and FIG. 4, when voltage is applied between the pixel electrode 21 and the common electrode 22 such that potential of the common electrode 22 is relatively high, the positively charged black particles 83 can be pulled into the pixel electrode 21 side in the microcapsule 80 by coulomb force, and the negatively charged white particles 82 can be pulled into the common electrode 22 side in the microcapsule 80 by coulomb force. As a result, the white particles 82 are collected on the display face side (i.e., the common electrode 22 side) in the microcapsule 80, and thus the color (i.e., white) of the white particles 82 can be displayed on the display face of the display unit 3. On the contrary, when voltage is applied between the pixel electrode 21 and the common electrode 22 such that potential of the pixel electrode 21 is relatively high, the negatively charged white particles 82 can be pulled into the pixel electrode 21 side by coulomb force, and the positively charged black particles 83 can be pulled into the common electrode 22 side by coulomb force. As a result, the black particles 83 are collected on the display face side of the microcapsule 80, and thus the color (i.e., black) of the black particles 83 can be displayed on the display face of the display unit 3.

Hereinafter, when the potential of the common electrode 22 is higher than the potential of the pixel electrode 21, the potential difference (i.e., voltage) generated between the common electrode 22 and the pixel electrode 21 is appropriately called “positive voltage”, and when the potential of the common electrode 22 is lower than the potential of the pixels electrode 21, potential difference generated between the common electrode 22 and the pixel electrode 21 is appropriately called “negative voltage”. The common electrode 22 is an example of a “first electrode” according to the invention, and the pixel electrode 21 is an example a “second electrode” according to the invention.

That is, white can be displayed on the pixel 20 by applying the positive voltage to the pixel 20, and black can be displayed on the pixel 20 by applying the negative voltage to the pixel 20. A state where the pixel 20 displays the white is an example of a “first display state” according to the invention, and a state where the pixel 20 displays the black is an example of a “second display state” according to the invention.

The common electrode 22 may be referred to as a “second electrode”, and the pixel electrode 21 may be referred to as a “first electrode”.

Gray colors such as light gray, gray, and dark gray, which are halftones (i.e., half gradations) between white and black can be displayed by the distribution state of the white particles 82 and the black particles 83 between the pixel electrode 21 and the common electrode 22. For example, voltage is applied between the pixel electrode 21 and the common electrode 22 such that the potential of the common electrode 22 is relatively high (i.e., positive voltage is applied), the white particles 82 are collected to the display face side of the microcapsule 80, the black particles 83 are collected to the pixel electrode 21 side, then voltage is applied between the pixel electrode 21 and the common electrode 22 only during a predetermined period according to the halftone to be displayed such that the potential of the pixel electrode 21 is relatively high (i.e., negative voltage is applied), a predetermined amount of black particles 83 are moved to the display face side of the microcapsule 80, and a predetermined amount of white particles 82 are moved to the pixel electrode 21 side. As a result, gray that is the halftone between white and black can be displayed on the display face of the display unit 3.

The pigments used for the white particles 82 and the black particles 83 are replaced by, for example, red, green, blue, and the like, and thus red, green, blue, and the like can be displayed.

Next, a method of driving the electrophoretic display device according to the embodiment will be described with reference to FIG. 5 to FIG. 8.

Hereinafter, for convenience of description, a case of displaying an image including halftones on the display unit 3 in which the pixels 20 of 3 rows×3 columns are arranged as shown in FIG. 5 according to the method of driving the electrophoretic display device according to the embodiment is exemplified. FIG. 5 is a schematic diagram illustrating the display unit of the electrophoretic display device in a state of displaying an example of the image including the halftones.

That is, as shown in FIG. 5, for example, gray (G) is displayed on a pixel PX (1, 1), white (W) is displayed on a pixel PX (1, 2), gray (G) is displayed on a pixel PX (1, 3), gray (G) is displayed on a pixel PX (2, 1), gray (G) is displayed on a pixel PX (2, 2), white (W) is displayed on a pixel PX (2, 3), gray (G) is displayed on a pixel PX (3, 1), gray (G) is displayed on a pixel PX (3, 2), and white (W) is displayed on a pixel PX (3, 3). In the display unit 3, the pixels 20 of 3 rows×3 columns (i.e., pixels PX (1, 1), PX (1, 2), PX (1, 3), . . . , PX (3, 1), PX (3, 2), PX (3, 3)) are arranged in a matrix. The display unit 3 is provided with three scanning lines 40 (i.e., scanning lines Y1, Y2, and Y3) and three data lines 50 (data lines X1, X2, and X3) (see FIG. 1). The pixel PX (1, 1) is disposed corresponding to the intersection of the scanning line Y1 and the data line X1, the pixel PX (1, 2) is disposed corresponding to the intersection of the scanning line Y1 and the data line X2, the pixel PX (1, 3) is disposed corresponding to the intersection of the scanning line Y1 and the data line X3, the pixel PX (2, 1) is disposed corresponding to the intersection of the scanning line Y2 and the data line X1, the pixel PX (2, 2) is disposed corresponding to the intersection of the scanning line Y2 and the data line X2, the pixel PX (2, 3) is disposed corresponding to the intersection of the scanning line Y2 and the data line X3, the pixel PX (3, 1) is disposed corresponding to the intersection of the scanning line Y3 and the data line X1, the pixel PX (3, 2) is disposed corresponding to the intersection of the scanning line Y3 and the data line X2, and the pixel PX (3, 3) is disposed corresponding to the intersection of the scanning line Y3 and the data line X3.

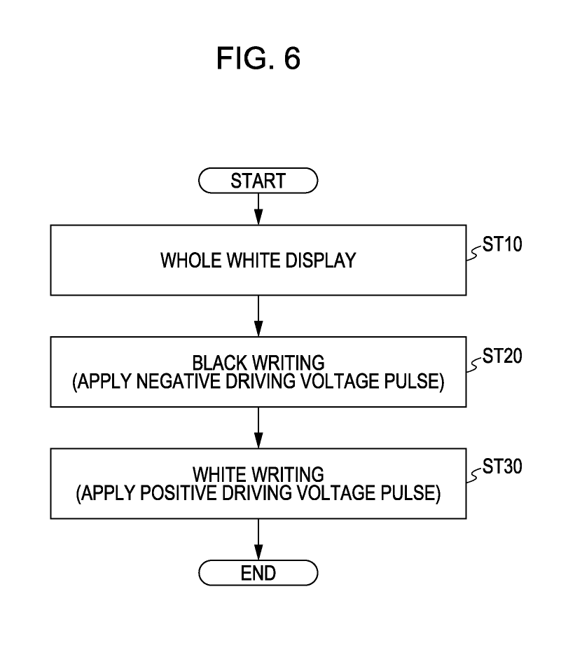

FIG. 6 is a flowchart illustrating the method of driving the electrophoretic display device according to the embodiment.

In FIG. 6, according to the method of driving the electrophoretic display device according to the embodiment, for example, when the image including the halftone shown in FIG. 5 is displayed, the whole white display is first performed (Step ST10). That is, positive voltage is applied to all the pixels 20 in the display unit 3 set to display white (W) in all the pixels 20. More specifically, for example, for the pixel PX (1, 1), a data signal is stored from the data line X1 to the capacitor 27 through the pixel switching transistor 24 to supply voltage of high potential VH to the pixel electrode 21 only during a predetermined time, and the common potential Vcom which is regular in low potential VL is supplied from the common potential supplying circuit 220 to the common electrode 22.

Then, black writing is performed (Step ST20). That is, negative driving voltage is applied between the pixel electrodes 21 of the pixels 20 (i.e., in the example shown in FIG. 5, the pixels PX (1, 1), PX (1, 3), PX (2, 1), PX (2, 2), PX (3, 1), and PX (3, 2)) set to display gray (G) in the display unit 3 and the common electrode 22, thus only a predetermined amount of black particles 83 are moved to the common electrode 22 side (i.e., the display face side), and only a predetermined amount of white electrodes 82 are moved to the pixel electrode 21 side.

Then, white writing is performed (Step ST30). That is, positive driving voltage is applied between the pixel electrodes 21 of the pixels 20 (in other words, the pixels 20 subjected to the black writing (Step ST20)) set to display gray (G) in the display unit 3 and the common electrode 22 only during a predetermined time, thus the black particles 83 are moved to the common electrode 22 side (i.e., the display face side), and the white particles 82 are moved to the pixel electrode 21 side. Accordingly, gray to be displayed (i.e., gray of target concentration) is displayed on the pixels 20 set to display gray.

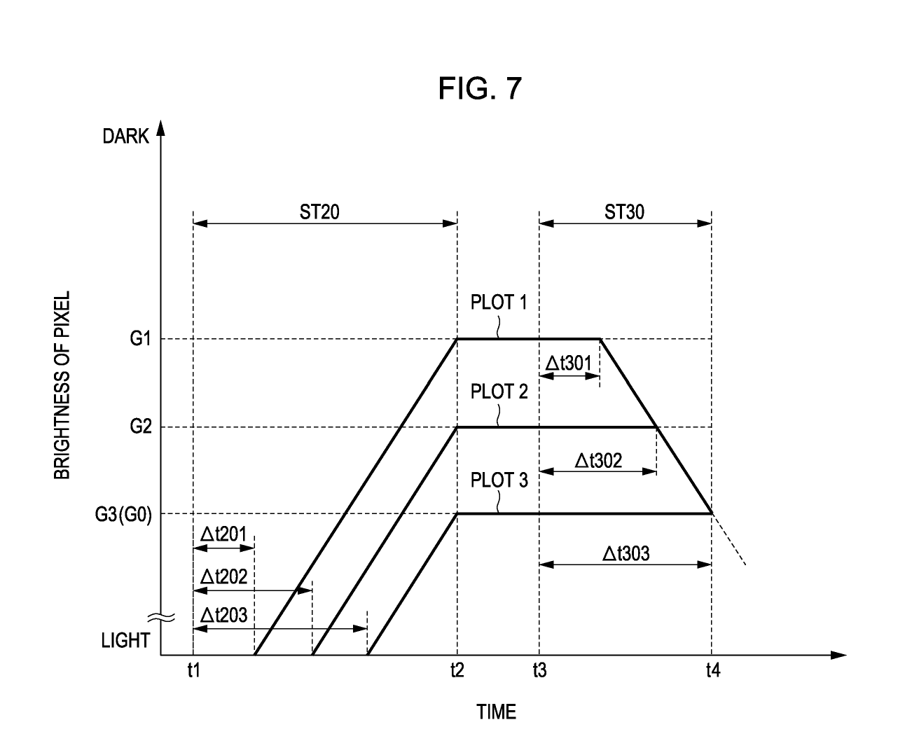

An operation of the invention will be described with reference to FIG. 7. FIG. 7 is a conceptual diagram illustrating an operation of the electrophoretic display device according to the embodiment. FIG. 7 conceptually shows color concentration change displayed on the pixels 20 to be displayed gray (G) by the black writing (Step ST20) and the white writing (Step ST30). The time t1 to the time t2 correspond to Step ST20, and the time t3 to the time t4 correspond to Step ST30. A plot 1 indicates change of brightness (color concentration) in the first pixel, a plot 2 indicates change of brightness (color concentration) in the second pixel, and a plot 3 indicates change of brightness (color concentration) in the third pixel. Δt is a delay time up to the time of starting to change the brightness after applying voltage, Δt201 is a delay time in Step ST20 in the first pixel, Δt202 is a delay time in Step ST20 in the second pixel, Δt203 is a delay time in Step ST20 in the third pixel, Δt301 is a delay time in Step ST30 in the first pixel, Δt302 is a delay time in Step ST30 in the second pixel, and Δt303 is a delay time in Step ST30 in the third pixel.

All of a gradation to be displayed for the first pixel, a gradation to be displayed for the second pixel, and a gradation to be displayed for the third pixel are a gradation G0, and it is assumed that negative driving voltage having the same continuation time is applied to each of the first pixel, the second pixel, and the third pixel. Originally, in Step ST20, when the negative driving voltage having the same continuation time is applied to display the gradation G0 on each of the first pixel, the second pixel, and the third pixel, all of the brightness of the first pixel, the brightness of the second pixel, and the brightness of the third pixel should be G0 for each time t2 when Step ST20 is completed. However, actually, as shown in FIG. 7, since there is a case where the delay time Δt is different depending on the pixel, the brightness of the first pixel is G1, the brightness of the second pixel is G2, and the brightness of the third pixel is G3 (G0) at the time t2. Difference between the brightness G1 and the brightness G3 (G0) is recognized as a noise of the displayed image. Such a noise gets more significant as the continuation time of the voltage applied to display the gradation gets shorter.

The driving method according to the embodiment of the invention includes Step ST30 after Step ST20. First, in Step ST20, as described above, the negative driving voltage having the same continuation time is applied to each of the first pixel, the second pixel, and the third pixel. Then, in Step ST30, when positive compensation voltage having the same continuation time is applied to each of the first pixel, the second pixel, and the third pixel, the brightness of the first pixel starts being changed toward the brightness direction after the delay time Δt301, and the brightness of the second pixel starts being changed toward the brightness direction after the delay time Δt302. However, herein, since the continuation time of Step ST30 is set equal to the delay time Δt303 of the third pixel, the brightness of the third pixel is not changed in Step ST30 and keeps the brightness G0.

According to an experiment of the inventors, it is thought that a cause of generation of the delay time is that threshold voltage for which the electrophoretic particles starts moving exists, and sufficient voltage is not applied to the electrophoretic layer when sufficient charges cannot be accumulated in the capacitor 27. To apply sufficient voltage to the pixel to start moving the electrophoretic particles, sufficient charges have to be accumulated in the capacitor 27. However, when there is individual difference in a charge rate of the capacitor 27 due to difference in production, it is thought that the time necessary until sufficient voltage is applied to the pixel after applying voltage to the capacitor 27 is different depending on the pixel. It is though that this phenomenon is one of the causes of the difference of the delay time Δt depending on the pixel. The delay time Δt201 is substantially equal to the delay time Δt301, the delay time Δt202 is substantially equal to the delay time Δt302, and the delay time Δt203 is substantially equal to the delay time Δt303.

Accordingly, at the completion time t4 of Step ST30, all of the brightness of the first pixel, the brightness of the second pixel, and the brightness of the third pixel are substantially the same, and it is possible to display substantially the same gradation as the desired gradation G0 for each of the first pixel, the second pixel, and the third pixel. That is, it is possible to reduce the noise of the displayed image.

In Step ST30, even when the continuation times of the compensation voltage applied to two pixels are different from each other, it is possible to reduce the difference in brightness of the two pixels. Accordingly, it is possible to obtain an effect of reducing the noise of the displayed image. However, when the difference in brightness between gradations displayed by two pixels is small, the magnitude of the noise has to be made smaller than the difference. Accordingly, it is more effective that the continuation times of the compensation voltage applied to two pixels are made equal to each other, and it is possible to effectively reduce the noise of the displayed image.

In FIG. 7, the continuation time of Step ST30 is set equal to the delay time Δt303 of the third pixel, but it is not necessary to be equal. When the continuation time of Step ST30 is at least longer than the delay time Δt303 of the third pixel, it is possible to obtain the effect of reducing the noise. When the continuation time of Step ST30 is longer than the delay time Δt303 of the third pixel, all of the brightness of the first pixel, the brightness of the second pixel, and the brightness of the third pixel are changed toward a bright state as shown by broken lines. However, when Step ST30 is completed, the brightness of the first pixel, the brightness of the second pixel, and the brightness of the third pixel can display substantially the same gradation. That is, it is possible to reduce the noise of the displayed image.

In FIG. 7, there is a gap between Step ST20 and Step ST30, and it is possible for a short gap to more effectively reduce the noise of the displayed image. It is preferable that there is no gap.

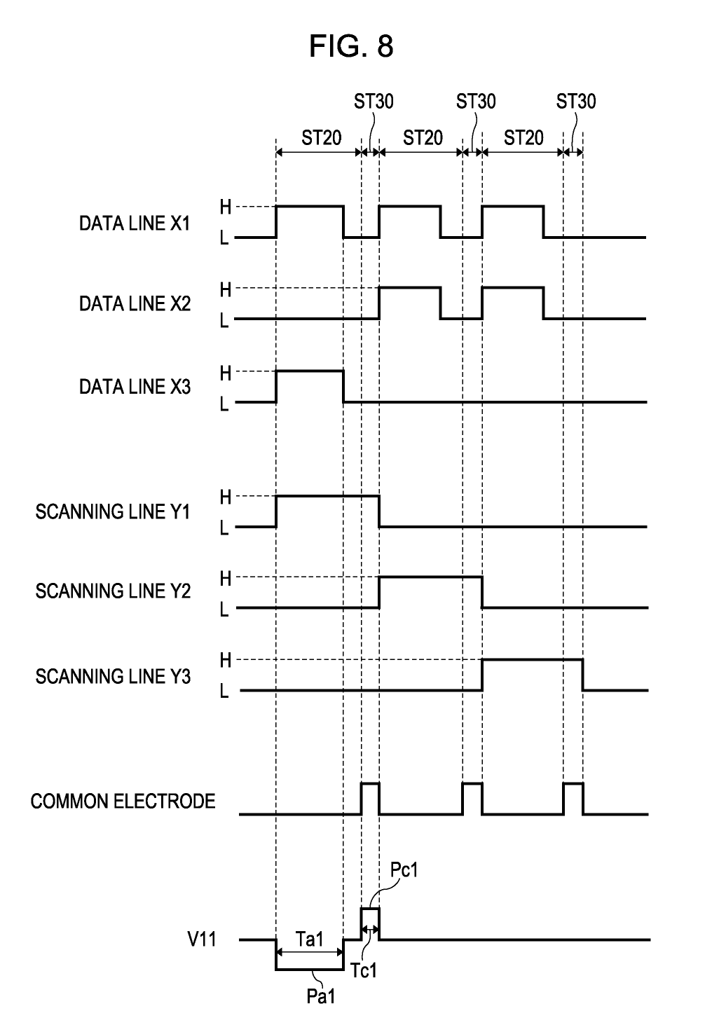

FIG. 8 is a timing chart for describing the method of driving the electrophoretic display device according to the embodiment in detail. FIG. 8 shows changes of potential of the data lines X1, X2, and X3, the scanning lines Y1, Y2, and Y3, and the common electrode 22 in the black writing (Step ST20) and the white writing (Step ST30). V11 shows a driving voltage waveform applied to the pixel PX (1, 1).

As shown in FIG. 8, the black writing (Step ST20) and the white writing (Step ST30) are performed for each period (i.e., a period when the potential of each of the scanning lines Y1, Y2, and Y3 becomes a high level) of selecting each of the scanning lines Y1, Y2, and Y3. In the black writing (Step ST20), a negative driving voltage pulse Pa1 having the continuation time Ta1 is applied to the pixel 20 set to display gray. In the white writing (Step ST30), a positive compensation voltage pulse Pc1 having the continuation time Tc1 is applied to all the pixels 20.

Specifically, after the white display (Step ST10) is performed, first, the scanning line Y1 becomes a high level (i.e., a high-level scanning signal is supplied to the scanning line Y1). During the period when the scanning line Y1 is at the high level, a data signal regular in the high potential VH is supplied to the data line X1 only during the time Ta1, a data signal regular in the low potential VL is supplied to the data line X2, a data signal regular in the high potential VH is supplied to the data line X3 only during the time Ta1, the black writing (Step ST20) is performed as the common electrode 22 comes to have the low potential VL (i.e., the common potential Vcom comes to have the low potential VL), after the black writing, a data signal regular in the low potential VL is supplied to the data lines X1, X2, and X3, and the white writing (Step ST30) is performed as the common electrode 22 comes to have the high potential VH (i.e., the common potential Vcom comes to have the high potential VH).

Then, the scanning line Y2 comes to be the high level. During the period when the scanning line Y2 is the high level, a data signal regular in the high potential VH is supplied to the data line X1 only during the time Ta1, a data signal regular in the high potential VH is supplied to the data line X2 only during the time Ta1, a data signal regular in the low potential VL is supplied to the data line X3, the black writing (Step ST20) is performed as the common electrode 22 comes to have the low potential VL, after the black writing, a data signal regular in the low potential VL is supplied to the data lines X1, X2, and X3, and the white writing (Step ST30) is performed as the common electrode 22 comes to have the high potential VH.

Then, the scanning line Y3 comes to be the high level. During the period when the scanning line Y3 is the high level, a data signal regular in the high potential VH is supplied to the data line X1 only during the time Ta1, a data signal regular in the high potential VH is supplied to the data line X2 only during the time Ta1, a data signal regular in the low potential VL is supplied to the data line X3, the black writing (Step ST20) is performed as the common electrode 22 comes to have the low potential VL, after the black writing, a data signal regular in the low potential VL is supplied to the data lines X1, X2, and X3, and the white writing (Step ST30) is performed as the common electrode 22 comes to have the high potential VH.

According to such a driving method, it is possible to display the image including the halftone shown in FIG. 5 on the display unit 3 with high quality.

As described above, in the embodiment, when the image including the halftone shown in FIG. 5 is displayed after the white display (Step ST10), the white writing (Step ST30) is performed after the black writing (Step ST20). That is, when the halftone is displayed on the pixel 20 subjected to the white display (Step ST10), the negative driving voltage pulse Pa1 is applied to the pixel 20, and then the positive compensation voltage pulse Pc1 is applied to all the pixels 20. Accordingly, it is possible to reduce or remove the noise of the displayed image. That is, it is possible to reduce the displaying of different halftones among the pixels 20 set to display the same halftone. That is, according to the method of driving the electrophoretic display device according to the embodiment, it is possible to effectively reduce or remove the noise (i.e., the noise when displaying the halftone) which tends to significantly occur as the time of applying the driving voltage gets shorter as described above, for example, as compared with the case of displaying the halftone in the pixel 20 by applying only the negative driving voltage pulse to the pixel 20 set to display the halftone. As a result, it is possible to perform high-quality display.

As described above, according to the electrophoretic display device of the embodiment, it is possible to reduce the noise when displaying the halftone, and thus it is possible to perform the high-quality display.

### MODIFIED EXAMPLE

In the first embodiment, the case of displaying the image including the halftone on the display unit 3 after performing the whole white display (Step ST10) is exemplified, but the image including the halftone may be displayed on the display unit 3 after the whole black display is performed (i.e., black is displayed in all the pixels 20) like the modified example.

That is, in the method of driving the electrophoretic display device according to the modified example, the whole black display is performed, and then the white writing (Step ST20b) and the black writing (Step ST30b) are performed in this order. In the white writing (Step ST20b), positive voltage is applied between the pixel electrode 21 and the common electrode 22 only during a predetermined period to the pixel 20 set to display gray. In the black writing (Step ST30b), the compensation voltage pulse is applied similarly to the first embodiment, but in the modified example, the polarity of the compensation voltage pulse is negative. As described above, gray (i.e., gray of target concentration) to be displayed for the pixel 20 is displayed.

Also according to the method of driving the electrophoretic display device of the modified example, similarly to the method of driving the electrophoretic display device according to the first embodiment, it is possible to reduce the noise when displaying the halftone, and it is possible to perform the high-quality display.

### Second Embodiment

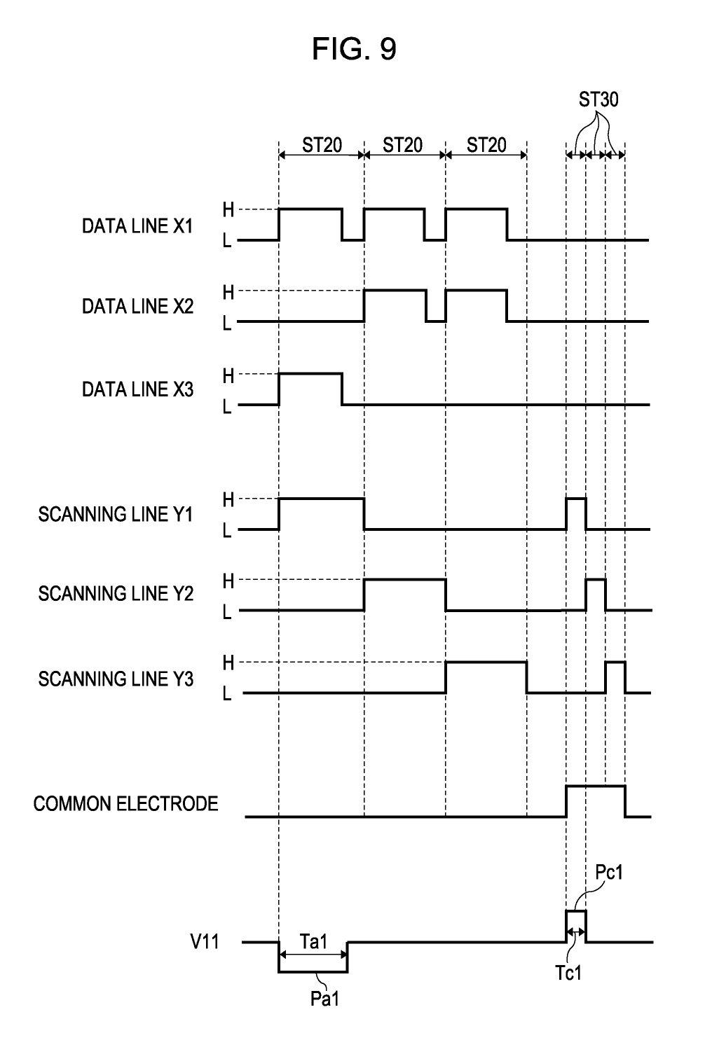

Next, a method of driving an electrophoretic display device according to a second embodiment will be described with reference to FIG. 9.

FIG. 9 is a timing chart for describing the method of driving the electrophoretic display device according to the second embodiment, and is a diagram for the same purpose as FIG. 8 shown in the first embodiment.

Hereinafter, points of difference of the method of driving the electrophoretic display device according to the second embodiment from the method of driving the electrophoretic display device according to the first embodiment will be mainly described, and the same configuration as the method of driving the electrophoretic display device according to the first embodiment is appropriately omitted. Also in the second embodiment, the case of displaying the image including the halftone shown in FIG. 5 on the display unit 3 is exemplified similarly to the first embodiment.

In the first embodiment described with reference to FIG. 8, the black writing (Step ST20) and the white writing (Step ST30) are performed for each period of selecting each of the scanning lines Y1, Y2, and Y3. However, as shown in FIG. 9 according to the second embodiment, the white writing (Step ST30) may be performed on all the pixels 20 after the black writing (Step ST20) is performed on all the pixels 20 set to display gray.

That is, as shown in FIG. 9, according to the method of driving the electrophoretic display device of the second embodiment, after the whole white display (Step ST10) is performed, first, the scanning lines 40 (i.e., scanning lines Y1, Y2, and Y3) are sequentially selected, and the black writing (Step ST20) is performed for each period of selecting the scanning lines 40. In this case, unlike the first embodiment, the white writing (Step ST30) is not performed. In other words, after the whole white display (Step ST10) is performed, first, the black writing (Step ST20) is performed on all the pixels 20 (i.e., in the example shown in FIG. 5, the pixels PX (1, 1), PX (1, 3), PX (2, 1), PX (2, 2), PX (3, 1), and PX (3, 2)) set to display gray in the display unit 3. That is, the negative driving voltage pulse Pa1 is applied to all the pixels 20 set to display gray in the display unit 3.

As described above, after the black writing (Step ST20) is performed on all the pixels 20 set to display gray in the display unit 3, the scanning lines 40 (i.e., scanning lines Y1, Y2, and Y3) are sequentially selected again, and the white writing (Step ST20) is performed for each period of selecting the scanning lines 40. That is, after the negative driving voltage pulse Pa1 is applied to all the pixels 20 set to display gray in the display unit 3, the positive compensation voltage pulse Pc1 is applied to all the pixels 20 of the display unit 3.

Also according to the method of driving the electrophoretic display device of the second embodiment, similarly to the method of driving the electrophoretic display device according to the first embodiment, it is possible to reduce the noise when displaying the halftone and it is possible to perform the high-quality display, as compared with the case of displaying the halftone on the pixel 20, for example, by applying only the negative driving voltage pulse to the pixel 20 set to display the halftone.

### Third Embodiment

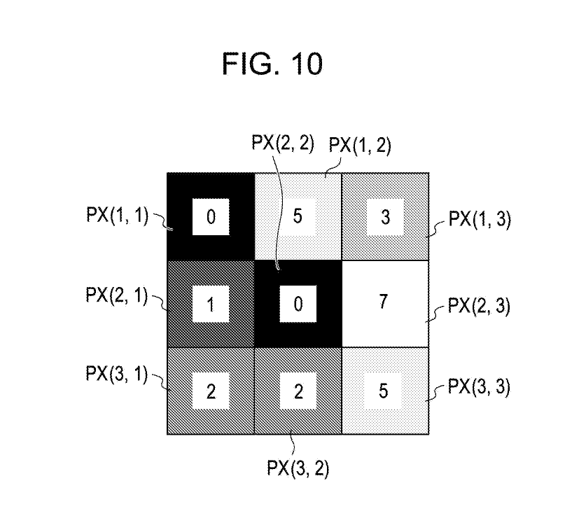

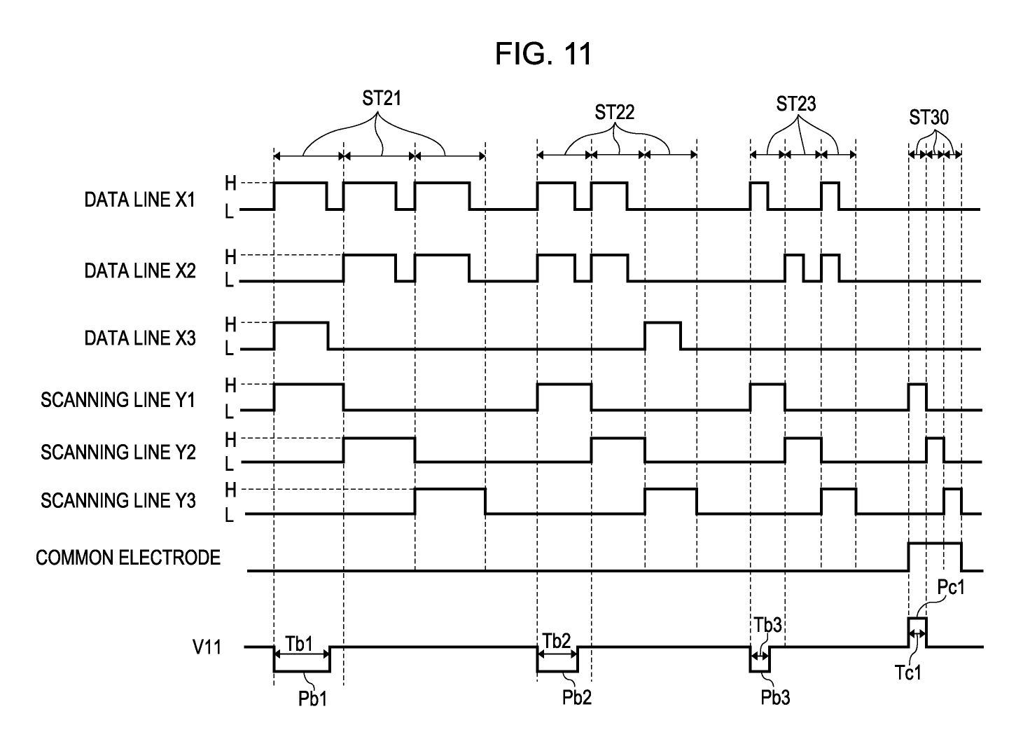

Next, a method of driving an electrophoretic display device according to a third embodiment will be described with reference to FIG. 10 and FIG. 11.

Hereinafter, a case of displaying an image including a plurality of halftones shown in FIG. 10 on the display unit 3 is exemplified. FIG. 10 is a schematic diagram illustrating the display unit of the electrophoretic display device displaying an example of the image including the plurality of halftones. The image including the plurality of halftones shown in FIG. 10 is an image of 8 gradations, the zeroth gradation corresponds to black, the first to the sixth gradations correspond to gray with different concentrations, and the seventh gradation corresponds to white.

That is, as shown in FIG. 10, for example, the zeroth gradation is displayed on the pixel PX (1, 1), the fifth gradation is displayed on the pixel PX (1, 2), the third gradation is displayed on the pixel PX (1, 3), the first gradation is displayed on the pixel PX (2, 1), the zeroth gradation is displayed on the pixel PX (2, 2), the seventh gradation is displayed on the pixel PX (2, 3), the second gradation is displayed on the pixel PX (3, 1), the second gradation is displayed on the pixel PX (3, 2), and the fifth gradation is displayed on the pixel PX (3, 3).

FIG. 11 is a timing chart for describing the method of driving the electrophoretic display device according to the third embodiment, and is a diagram for the same purpose as FIG. 9 shown in the second embodiment.

The method of driving the electrophoretic display device according to the third embodiment is a driving method in the case of displaying the image including the plurality of halftones, which is different from the method of driving the electrophoretic display device according to the second embodiment, and in other points, is substantially the same as the method of driving the electrophoretic display device according to the second embodiment. Hereinafter, the points of difference of the method of driving the electrophoretic display device according to the third embodiment from the method of driving the electrophoretic display device according to the second embodiment will be mainly described, and the same configuration as the method of driving the electrophoretic display device according to the second embodiment is appropriately omitted.

As shown in FIG. 11, according to the method of driving the electrophoretic display device of the third embodiment, the white writing (Step ST30) is performed on all the pixels 20 after performing the black writing (Steps ST21, ST22, and ST23) on all the pixels 20 (i.e., the pixels 20 set to display any of the zeroth to the sixth gradations) except for the pixel PX (2, 3) set to display the seventh gradation (i.e., white) among the plurality of pixels 20 in the display unit 3.

In the third embodiment, at least one negative driving voltage pulse of three kinds of negative driving voltage pulses Pb1, Pb2, and Pb3 with different continuation times is applied to the pixel 20, set to display any of the zeroth to the seventh gradations on the pixel 20. The continuation time Tb1 of the negative driving voltage pulse Pb1 is four times the continuation time Tb3 of the negative driving voltage pulse Pb3, and the continuation time Tb2 of the negative driving voltage pulse Pb2 is twice the continuation time Tb3 of the negative driving voltage pulse Pb3 (i.e., ½ times the continuation time Tb1 of the negative driving voltage pulse Pb1). However, such ratios may be appropriately set according to the ease of movement of the electrophoretic particles set to display 8 gradations. When the negative driving voltage pulses Pb1, Pb2, and Pb3 are applied to the pixel 20, the pixel 20 displays the zeroth gradation (i.e., black), when the negative driving voltage pulses Pb1 and Pb2 are applied to the pixel 20, the pixel 20 displays the first gradation, when the negative driving voltage pulses Pb1 and Pb3 are applied to the pixel 20, the pixel 20 displays the second gradation, when the negative driving voltage pulse Pb1 is applied to the pixel 20, the pixel 20 displays the third gradation, when the negative driving voltage pulses Pb2 and Pb3 are applied to the pixel 20, the pixel 20 displays the fourth gradation, when the negative driving voltage pulse Pb2 is applied to the pixel 20, the pixel 20 displays the fifth gradation, when the negative driving voltage pulse Pb3 is applied to the pixel 20, the pixel 20 displays the sixth gradation, and when none of the negative driving voltage pulses Pb1, Pb2, and Pb3 are applied to the pixel 20, the pixel 20 displays the zeroth gradation.

That is, as shown in FIG. 11, according to the method of driving the electrophoretic display device of the third embodiment, after performing the whole white display (Step ST10), first, the scanning lines 40 (i.e., the scanning lines Y1, Y2, and Y3) are sequentially selected, the black writing (Step ST21) of applying the negative driving voltage pulse Pb1 is performed for each period of selecting the scanning lines 40. In the black writing (Step ST21), the negative driving voltage pulse Pb1 is applied to the pixels 20 (i.e., in the example shown in FIG. 10, the pixels PX (1, 1), PX (2, 1), PX (3, 1), PX (2, 2), PX (2, 3), and PX (1, 3)) set to display any of the zeroth to the third gradations. Then, the scanning lines 40 (i.e., the scanning lines Y1, Y2, and Y3) are sequentially selected again, and the black writing (Step ST22) of applying the negative driving voltage pulse Pb2 is performed for each period of selecting the scanning lines 40. In the black writing (Step ST22), the negative driving voltage pulse Pb1 is applied to the pixels 20 (i.e., in the example shown in FIG. 10, the pixels PX (1, 1), PX (2, 2), PX (2, 1), PX (2, 2), and PX (3, 3)) set to display any of the zeroth, the first, the fourth, and the fifth gradations. Then, the scanning lines 40 (i.e., the scanning lines Y1, Y2, and Y3) are sequentially selected again, and the black writing (Step ST23) of applying the negative driving voltage pulse Pb3 is performed for each period of selecting the scanning lines 40. In the black writing (Step ST23), the negative driving voltage pulse Pb3 is applied to the pixels 20 (i.e., in the example shown in FIG. 10, the pixels PX (1, 1), PX (2, 2), PX (3, 1), and PX (3, 2)) set to display any of the zeroth, the second, the fourth, and the sixth gradations.

As described above, after the black writing (Steps ST21, ST22, and ST23) is performed on all the pixels 20 in the display unit 3, the scanning lines 40 (i.e., the scanning lines Y1, Y2, and Y3) are sequentially selected again, and the white writing (Step ST20) is performed for each period of selecting the scanning lines 40. That is, after all the negative driving voltage pulses necessary to display the target gradation among the negative driving voltage pulses Pb1, pb2, and Pb3 are applied to all the pixels 20 in the display unit 3, the positive compensation voltage pulse Pc1 is applied to all the pixels 20 of the display unit 3.

According to the electrophoretic display device of the third embodiment, it is possible to display the image having the plurality of halftones shown in FIG. 10 on the display unit 3 with high quality.

In the embodiment, as described above, when the image including the plurality of halftones shown in FIG. 10 is displayed after performing the white display (Step ST10), the white writing (Step ST30) is performed after performing the black writing (Steps ST21, ST22, and ST23). Accordingly, it is possible to reduce or remove the noise of the image displayed by the plurality of pixels 20 arranged in the display unit 3, by the white writing (Step ST30).

In the embodiment, the continuation time Tc1 of the positive compensation voltage pulse Pc1 is shorter than the total continuation time (i.e., the sum of the continuation times Tb1, Tb2, and Tb3) of the negative driving voltage pulses Pb1, Pb2, and Pb3. Accordingly, it is possible to effectively reduce or remove the noise of the displayed image. In addition, it is possible to rapidly display the halftone, as compared with the case where the continuation time Tc1 of the positive compensation voltage pulse Pc1 is longer than the total continuation time of the negative driving voltage pulses Pb1, Pb2, and Pb3 (i.e., it is possible to shorten the time necessary to display the halftone to be display by the pixel 20). Moreover, it is possible to suppress power consumption necessary to apply the positive compensation voltage pulse Pc1.

### Fourth Embodiment

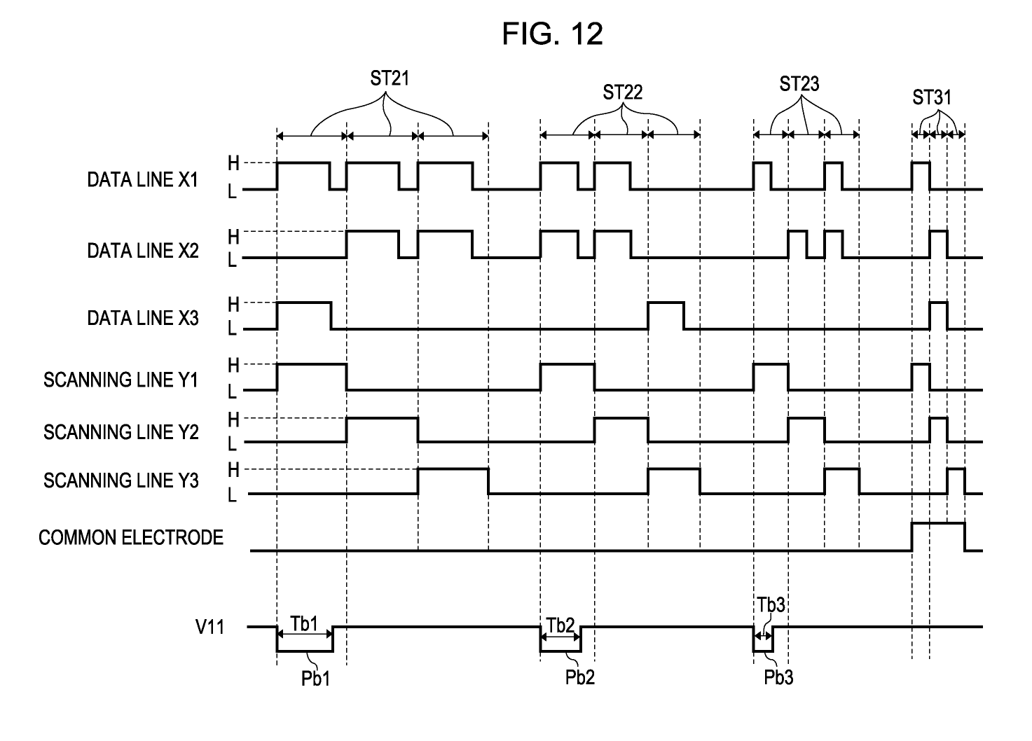

Next, a method of driving an electrophoretic display device according to a fourth embodiment will be described with reference to FIG. 12.

FIG. 12 is a timing chart for describing the method of driving the electrophoretic display device according to the fourth embodiment, and is a diagram for the same purpose as FIG. 11 shown in the third embodiment.

Hereinafter, the points of difference of the method of driving the electrophoretic display device according to the fourth embodiment from the method of driving the electrophoretic display device according to the third embodiment will be mainly described, and the same configuration as the method of driving the electrophoretic display device according to the third embodiment is appropriately omitted. Also in the fourth embodiment, the example of displaying the image including the plurality of halftones shown in FIG. 10 on the display unit 3 similarly to the third embodiment is exemplified.

In the method of driving the electrophoretic display device according to the third embodiment, the white writing (Step ST30) of applying the positive compensation voltage pulse Pc1 to all the pixels 20 is performed after performing the black writing (Steps ST21, ST22, and ST23), but the white writing (Step ST31) of applying the positive compensation voltage pulse Pc1 only to the pixel 20 displaying the halftone may be performed in the same manner as the embodiment.

That is, as shown in FIG. 12, in the method of driving the electrophoretic display device according to the embodiment, the black writing (Steps ST21, ST22, and ST23) and the white writing (Step ST31) are performed after performing the whole white display (Step ST10). In the white writing (Step ST31), the positive compensation voltage pulse Pc1 is applied to the pixel 20 displaying the halftone (i.e., the pixel 20 displaying any of the first to the sixth gradations), and the positive compensation voltage pulse Pc1 is not applied to the pixel 20 displaying the lowest gradation or the highest gradation (i.e., the pixel 20 displaying the zeroth or the seventh gradation). In other words, in the white writing (Step ST31), the common electrode 22 comes to have the high potential VH, the data signal of the low potential VL is supplied to the pixel 20 displaying the halftone, and the data signal of the high potential VH is supplied to the pixel 20 displaying the lowest gradation or the highest gradation. In the example shown in FIG. 10, in the white writing (Step ST31), the positive compensation voltage pulse Pc1 is applied to the pixels PX (1, 2), PX (1, 3), PX (2, 1), PX (3, 1), PX (3, 2), and PX (3, 3) that are the pixels 20 displaying the halftones, and the positive compensation voltage pulse Pc1 is not applied to the pixels PX (1, 1), PX (2, 2) and PX (2, 3) that are the pixels 20 displaying the lowest gradation or the highest gradation (i.e., potential difference is not generated between the pixel electrode 21 and the common electrode 22).

Accordingly, for example the positive compensation voltage pulse Pc1 is applied to the pixel 20 displaying black (i.e., the zeroth gradation), and thus it is possible to prevent the displayed color (or the gradation) of the pixel 20 from deviating toward white (i.e. the seventh gradation). Accordingly, it is possible to effectively reduce or remove the noise of the displayed image, and also it is possible to raise the contrast.

### Fifth Embodiment

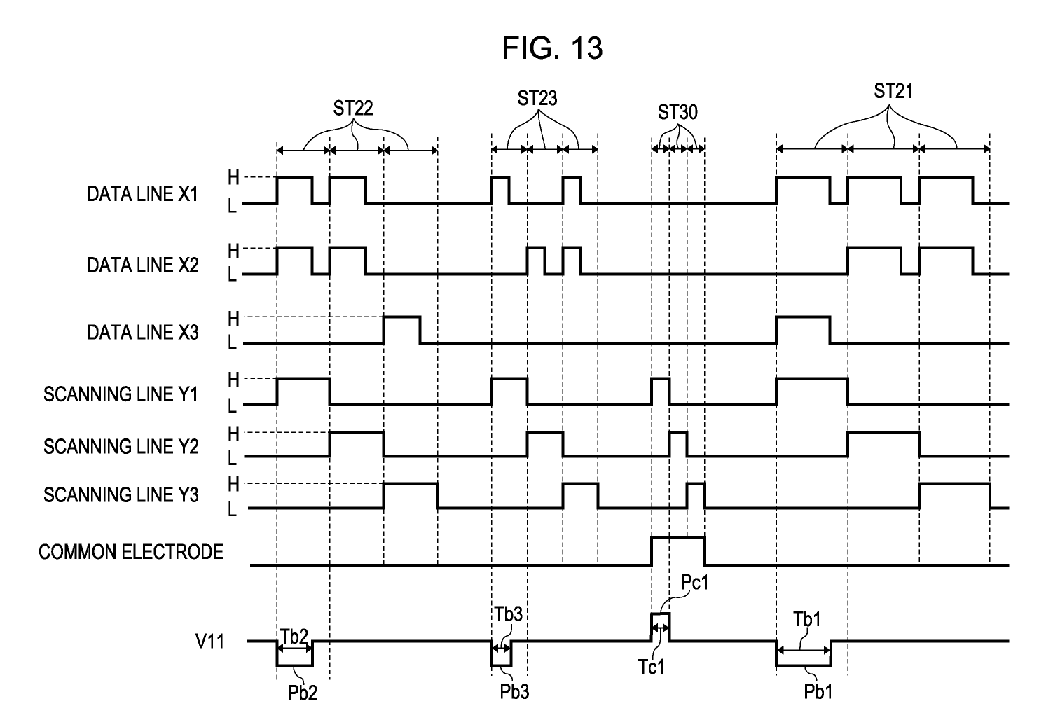

Next, a method of driving an electrophoretic display device according to a fifth embodiment will be described with reference to FIG. 13.

FIG. 13 is a timing chart for describing the method of driving the electrophoretic display device according to the fifth embodiment, and is a diagram for the same purpose as FIG. 11 shown in the third embodiment.

Hereinafter, the points of difference of the method of driving the electrophoretic display device according to the fifth embodiment from the method of driving the electrophoretic display device according to the third embodiment will be mainly described, and the same configuration as the method of driving the electrophoretic display device according to the third embodiment is appropriately omitted. Also in the fifth embodiment, the example of displaying the image including the plurality of halftones shown in FIG. 10 on the display unit 3 similarly to the third embodiment is exemplified.

In the method of driving the electrophoretic display device according to the third embodiment, the white writing (Step ST30) of applying the positive compensation voltage pulse Pc1 to all the pixels 20 is performed after performing the black writing (Steps ST21, ST22, and ST23), but the black writing (Step ST21) of applying the negative driving voltage pulse Pb1 of the longest continuation time among the negative driving voltage pulses Pb1, Pb2, and Pb3 to the pixel 20 may be lastly provided, and the white writing (Step ST30) may be performed just before the black writing (Step ST21) in the same manner as the embodiment. As described above, the continuation time Tb1 of the negative driving voltage pulse Pb1 is, for example, four times the continuation time Tb3 of the negative driving voltage pulse Pb3, and the continuation time Tb2 of the negative driving voltage pulse Pb2 is, for example, twice the continuation time Tb3 of the negative driving voltage pulse Pb3.

That is, as shown in FIG. 13, in the method of driving the electrophoretic display device of the embodiment, after the whole white display (Step ST10) is performed, the black writing (Step ST22) of applying the negative driving voltage pulse Pb2 to the pixel 20 and the black writing (Step ST23) of applying the negative driving voltage pulse Pb3 to the pixel 20 are performed. The order of performing the black writing (Steps ST22 and ST23) is not limited, and any black writing may be first performed. After performing the black writing (Steps ST22 and ST23), the white writing (Step ST30) of applying the positive compensation voltage pulse Pc1 to all the pixels 20 of the display unit 3 is performed. After the white writing (Step ST30) is performed, the black writing (Step ST21) of applying the negative driving voltage pulse Pb1 of the longest continuation time among the negative driving voltage pulses Pb1, Pb2, and Pb3 to the pixel 20 is performed.

According to the method of driving the electrophoretic display device of the fifth embodiment, it is possible to display the image having the plurality of halftones shown in FIG. 10 on the display unit 3 with high quality.

In the embodiment, as described above, when the image including the plurality of halftones shown in FIG. 10 is displayed after performing the white display (Step ST10), the white writing (Step ST30) is performed after performing the black writing (Steps ST22 and ST23). Accordingly, it is possible to reduce or remove the noise of the image displayed by the plurality of pixels 20 arranged in the display unit 3, by the white writing (Step ST30). In the embodiment, as described above, the black writing (Step ST21) of applying the negative driving voltage pulse Pb1 of the longest continuation time among the negative driving voltage pulses Pb1, Pb2, and Pb3 to the pixel 20 is lastly performed, and the white writing (Step ST30) of applying the positive compensation voltage pulse Pc1 to the pixel 20 is performed just before the black writing (Step ST21). Accordingly, it is possible to reduce the occurrence of the pixels 20 (i.e., in the example shown in FIG. 10, the pixels PX (1, 1), PX (1, 3), PX (2, 1), PX (2, 2), PX (3, 1), and PX (3, 2)) to which the negative driving voltage pulse Pb1 is applied and comes to be closer to white than gray or black to be displayed, by the white writing (Step ST30). Therefore, it is possible to effectively reduce or remove the noise of the displayed image, and also it is possible to raise the contrast of the displayed image. Particularly, it is possible to reduce the occurrence of black being displayed by the pixels 20 (i.e., in the example shown in FIG. 10, the pixels PX (1, 1) and PX (2, 2)) set to display black come to be close to white by the white writing (Step ST30), and thus it is possible to reliably raise the contrast of the displayed image.

The invention is not limited to the above-described embodiments, and can be appropriately modified within the scope which is not against the main concept or sprit of the invention which is able to be read from the claims and the whole specification, and the method of driving the electrophoretic display device with such modification is also included in the technical scope of the invention.

The entire disclosure of Japanese Patent Application No. 2010-024154, filed Feb. 5, 2010 is expressly incorporated by reference herein.

What is claimed is:

1. A method of driving an electrophoretic display device provided with a plurality of pixels with an electrophoretic layer interposed between a first electrode and a second electrode, wherein when assuming that a potential difference occurring between the first electrode and the second electrode is positive in a case where a potential of the first electrode is higher than a potential of the second electrode, a first display state is selected as a display state of the pixels by applying the positive voltage, a second display state is selected as a display state of the pixels by applying a negative voltage different from the positive voltage, and a halftone between the first display state and the second display state is selected according to a total continuation time of the negative voltage applied to the pixels in the first display state, the method comprising applying a positive compensation voltage pulse after applying at least one negative driving voltage pulse to select the halftone.

2. The method of driving the electrophoretic display device according to claim 1, wherein a continuation time of the compensation voltage pulse is shorter than the total continuation time of at least one negative driving voltage pulse.

3. The method of driving the electrophoretic display device according to claim 1, wherein the continuation time of the compensation voltage pulse is longer than the total continuation time of at least one negative driving voltage pulse.

4. The method of driving the electrophoretic display device according to claim 1, wherein the compensation voltage pulse is applied after applying all of at least one negative driving voltage pulse.

5. The method of driving the electrophoretic display device according to claim 1, wherein the compensation voltage pulse is not applied to the pixels for which the second display state is selected.

6. The method of driving the electrophoretic display device according to claim 1, wherein a driving voltage pulse with the longest continuation time of at least one negative driving voltage pulse is lastly applied, and the compensation voltage pulse is applied just before the lastly applied driving voltage pulse.

7. A controller for an electrophoretic display device provided with a plurality of pixels with an electrophoretic layer interposed between a first electrode and a second electrode, wherein when assuming that a potential difference occurring between the first electrode and the second electrode is positive in a case where a potential of the first electrode is higher than a potential of the second electrode, a first display state is selected as a display state of the pixels by applying the positive voltage, a second display state is selected as a display state of the pixels by applying a negative voltage different from the positive voltage, and a halftone between the first display state and the second display state is selected according to a total continuation time of the negative voltage applied to the pixels in the first display state,
wherein the controller executes a driving method comprising:
applying a positive compensation voltage pulse after applying at least one negative driving voltage pulse to select the halftone.

8. The controller according to claim 7, wherein a continuation time of the compensation voltage pulse is shorter than the total continuation time of at least one negative driving voltage pulse.

9. The controller according to claim 7, wherein the continuation time of the compensation voltage pulse is longer than the total continuation time of at least one negative driving voltage pulse.

10. The controller according to claim 7, wherein the compensation voltage pulse is applied after applying all of at least one negative driving voltage pulse.

11. The controller according to claim 7, wherein the compensation voltage pulse is not applied to the pixels for which the second display state is selected.

12. The controller according to claim 7, wherein a driving voltage pulse with the longest continuation time of at least one negative driving voltage pulse is lastly applied, and the compensation voltage pulse is applied just before the lastly applied driving voltage pulse.
